(19) United States
(12) Patent Application Publication
(10) Pub. No.: US 2013/0135446 A1
(43) Pub. Date: May 30, 2013

(54) STREET VIEW CREATING SYSTEM AND METHOD THEREOF

(71) Applicants: HOU-HSIEN LEE, Tu-Cheng (TW); CHANG-JUNG LEE, Tu-Cheng (TW); CHIH-PING LO, Tu-Cheng (TW)

(72) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 13/329,228

(22) Filed: Dec. 17, 2011

(30) Foreign Application Priority Data
Nov. 28, 2011 (TW) 100143618

(51) Int. Cl. H04N 13/02

(52) U.S. Cl. 348/48; 348/E13.074

(57) ABSTRACT

An exemplary street view creating method includes obtaining images captured by at least three cameras in close proximity. The method then extracts the distance information from the obtained images. Next, the method determines images captured by cameras in different orientations and at different precise locations. The method further creates virtual 3D models based on the determined images and the extracted distance information. Then, the method determines any overlapping portion between any two original images. The method aligns any portions of synchronous images which are determined as common or overlapping.

### BACKGROUND

1. Technical Field

The present disclosure relates to street view creating systems and methods thereof, and particularly, to a street view creating system for creating street view using a three-dimensional camera and a method thereof.

2. Description of Related Art

Many street view creating systems capture images through a two-dimensional (2D) camera, and stitch the captured images together using a software to create a panorama with a near 360 degree viewing angle. However, in these street view creating systems, the combined street view may be distorted. Therefore, it is desirable to provide a new street view creating system to resolve the above problems.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a schematic diagram illustrating a street view creating device connected to a number of cameras, a compass and a positioning device in accordance with an exemplary embodiment.

FIG. 2 is a schematic view illustrating the distribution of the cameras of FIG. 1, in accordance with an exemplary embodiment.

FIG. 3 is a block diagram of a street view creating system of FIG. 1.

FIG. 4 is a schematic diagram illustrating creating a virtual 3D model of the street.

FIG. 5 is a flowchart of a street view creating method in accordance with an exemplary embodiment.

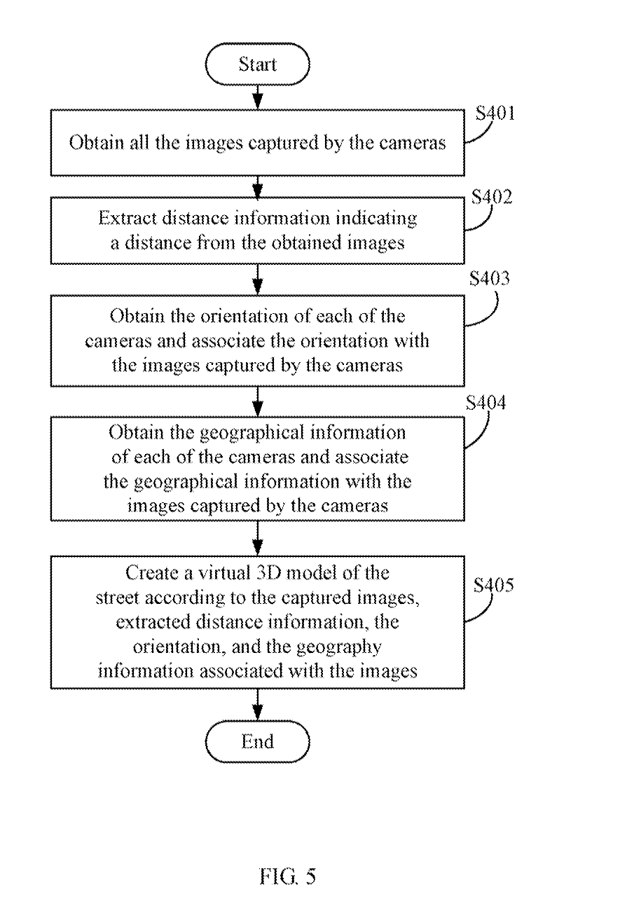

### DETAILED DESCRIPTION

The embodiments of the present disclosure are described with reference to the accompanying drawings.

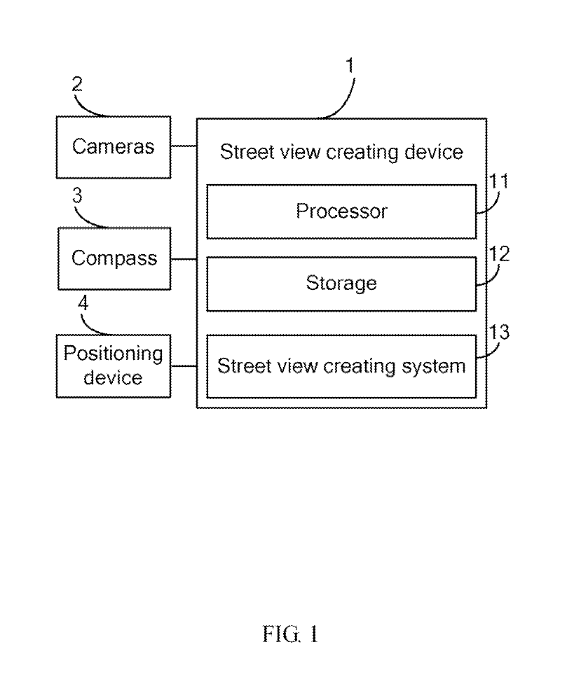

Referring to FIG. 1, a schematic diagram illustrating a device to create certain images of city and other streets (street view creating device 1) shows the device 1 connected to at least three cameras 2, a compass 3, and a positioning device 4. The street view creating device 1 can create street views based on the images captured by the camera 2, the orientation of the camera 2 as detected by the compass 3, and the geographical information of the camera 2 supplied by the position device 4.

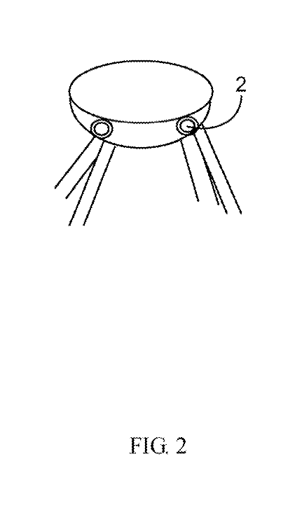

Each captured image includes distance information indicating the distance between one camera 2 and any object in the field of view of the camera 2. In the embodiment, the camera 2 is a TOF (Time of Flight) camera. As shown in FIG. 2, in the embodiment, there are three cameras 2 taken as an example, the cameras 2 are equidistant from each other. The images captured by the three cameras 2 can be combined together to create a single panoramic image which nevertheless reflects the slightly different location of each of the three cameras 2 and appears to be three-dimensional (3D). In the embodiment, the locations of each of the three cameras 2 are considered to be one location because the cameras 2 are very close to each other, and this one location is considered as the location where the single panoramic image was captured.

The street view creating device 1 includes at least one processor 11, a storage 12, and a street view creating system 13. In the embodiment, the quantity of the processor 11 is one. In an alternative embodiment, the number of the processor 11 may be more than one.

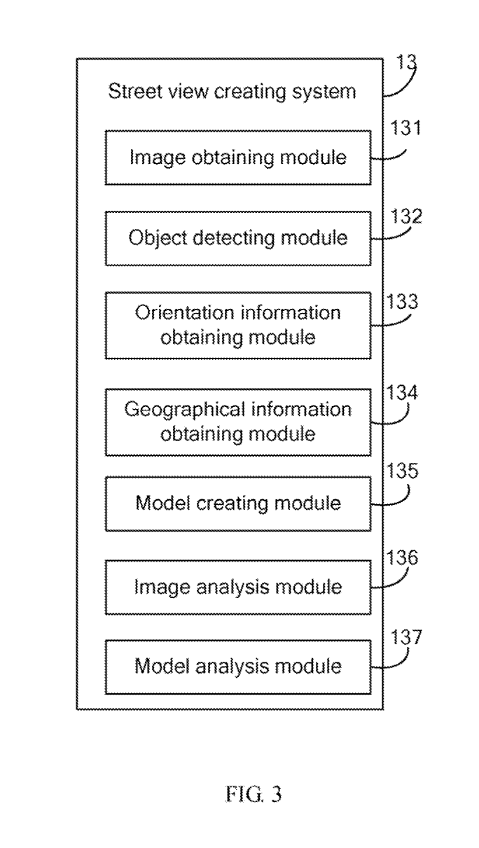

Referring to FIG. 3, in the embodiment, the street view creating system 13 includes an image obtaining module 131, an object detecting module 132, an orientation information obtaining module 133, a geographical information obtaining module 134, and a model creating module 135. One or more programs of the above function modules may be stored in the storage 12 and executed by the processor 11. In general, the word “module,” as used herein, refers to logic embodied in hardware or firmware, or to a collection of software instructions, written in a programming language. The software instructions in the modules may be embedded in firmware, such as in an erasable programmable read-only memory (EPROM) device. The modules described herein may be implemented as either software and/or hardware modules and may be stored in any type of computer-readable medium or other storage device.

The image obtaining module 131 obtains the images captured by the three cameras 2.

The object detecting module 132 extracts the distance information in relation to the distance(s) between the cameras 2 and each of the objects appearing in the captured images. In the embodiment, the object detecting module 132 extracts the distance information using a Robust Real-time Object Detection Method which method is well-known to one of ordinary skill in the art.

The orientation information obtaining module 133 obtains the individual orientations of each of the cameras 2, as detected by the compass 3, and associates the orientation of each camera with the images captured by that cameras 2. In the embodiment, the orientations of each of the cameras is the captured the angle of each of the cameras.

The geographical information obtaining module 134 obtains the geographical information of each of the cameras 2, as detected by the positioning device 4, and associates the geographical information with the images captured by the cameras 2. In the embodiment, the geographical information is represented by the longitude data and latitude data.

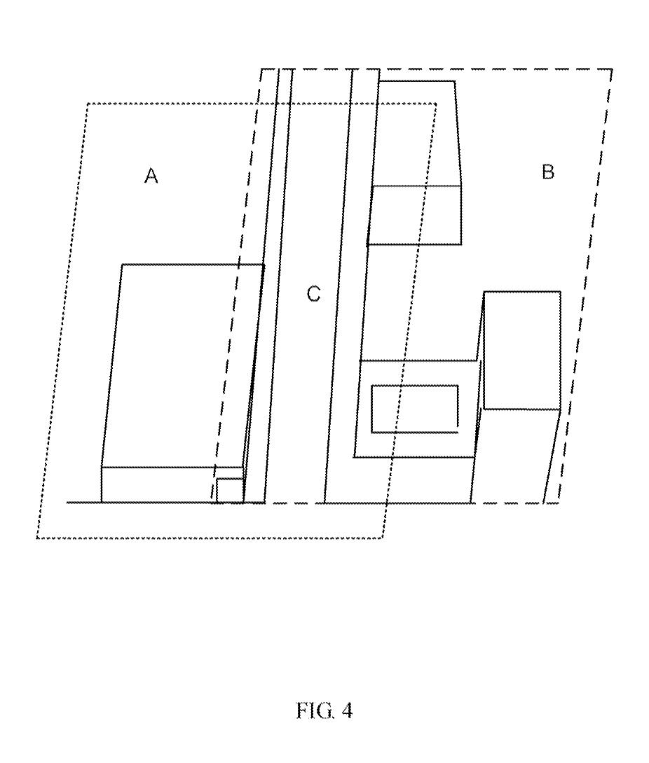

The model creating module 135 determines the images captured by cameras in different orientations and at different precise locations, and further creates 3D models according to the determined images and the extracted distance information. The model creating module 135 further determines any overlapping portions between the images contributed by each of the cameras 2, and further aligns any determined overlapping portion to create (on a two-dimensional display screen not shown) a virtual 3D model of the street. For example, in FIG. 4, suppose the camera 2A (not marked) of the cameras 2 captured the view shown in view/model A<<choose one>> (represented by the dotted lines enclosing the letter “A”) and camera 2B (not marked) captured the view shown in view/model B (represented by the broken lines enclosing the letter “B”), there is a part of both images which are the same. This common part is the overlapping portion between the two views/models A and B, thus the model creating module 135 aligns the common or overlapping portions (in FIG. 4 shown as the area around the letter “C”, enclosed partly by dotted lines and partly by broken lines) to obtain a virtual 3D model or representation of the street.

In the embodiment, the street view creating system 13 further includes an image analysis module 136. The image analysis module 136 determines which of the images include moving objects and which of the images do not. In the embodiment, the moving object(s) may be a person, an animal, a vehicle, or the like.

In detail, the cameras 2 may be mounted on a vehicle which moves very slowly, thus the cameras 2 can capture a large number of images at one geographical location, to obtain a number of images at each location. In an alternative embodiment, the vehicle may be driven back and forth such that the cameras 2 can capture substantially repeating images at the one location several times to obtain a number of images at each location.

The image analysis module 136 determines all the images attributable to one camera of the cameras 2 according to the orientation and geographical information associated with each image, and compares the distance information of the determined images to determine whether the determined images include any moving object(s) so that any image containing a moving object can be excluded. If the relationship between the different parts of distance information from one captured image is different from the relationship between the different parts of distance information from another captured image, the image analysis module 136 determines that there is a moving object(s) included in the image.

The image analysis module 136 can further determine the images which do not include any moving object(s) as those which do not include any moving object. The model creating module 135 may further produce virtual 3D models of the street based on the determined images which do not include any moving object(s) and the extracted distance information.

In the embodiment, the street view creating system 13 further includes a model analysis module 137. The model analysis module 137 is operable to obtain the pixel values of each pixel in each of the images captured at one geographical location and which do no include moving object(s), to determine an average pixel value of each pixel of the all images captured at the same location, and assign the determined average pixel value of each pixel of the images to the corresponding pixel of the single composite image which shows a virtual 3D model of the street to create a street view with color. In this way, every street view may be viewed in color, which will bring reality to the user.

Referring to FIG. 4, a street view creating method in accordance with an exemplary embodiment is shown.

In step S401, the image obtaining module 131 obtains all the images captured by each of the three cameras 2.

In step S402, the object detecting module 132 extracts the distance information indicating the distances between each one of the cameras 2 and the objects within each respective image captured.

In step S403, the orientation information obtaining module 133 obtains the orientation of each of the cameras 2 as detected by the compass 3, and associates the particular orientation with the images captured by a particular camera of the cameras 2.

In step S404, the geographical information obtaining module 134 obtains the geographical information of each of the cameras 2 as detected by the positioning device 4, and associates the geographical position with each of the images captured by each of the cameras 2.

In step S405, the model creating module 135 determines and classifies the images that are captured in different orientations and at different precise locations within the general geographical location, and creates a model of the street based on the determined images and the extracted distance information which appears to be in three dimensions. The model creating module 135 further determines the presence of any overlapping portion between synchronous images taken by two different cameras, and aligns any overlapping portions so determined to create a virtual 3D model of the street.

In the embodiment, the creation of the 3D image is performed after the image analysis module 136 has determined that no moving objects exist in the images, after any image determined as containing a moving object has been rejected (see paragraph [0031]).

In detail, the image analysis module 136 determines images which have been captured in the same orientation and at the same location according to the orientation and the geographical information associated with each image, and compares all parts of the distance information of the determined images to determine whether the images include moving object(s). If there is one or more images in which the relationship between the different parts of the distance information is different from the relationship between the different parts of the distance information in another substantially synchronous image, the image analysis module 136 determines that there is a moving object(s) included in the one or more image(s), and thus isolates and determines the images which do not include any moving object(s). The model creating module 135 creates the virtual 3D composite model with any included overlapping according to the determined images which do not include any moving object(s) and the extracted distance information.

In the embodiment, the creation of the virtual 3D model is preformed before a model analysis module 137 creates a virtual 3D street view.

In detail, the model analysis module 137 obtains the pixel value of each pixel in each of the images captured at the same location except for any pixels determined as representing a moving object, determines the average pixel value of all the pixels in all of the images captured at the one geographical location pixel by pixel, and composes an average pixel value for the corresponding virtual 3D model to create a 3D street view in color.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A street view creating device comprising:
a storage;
a processor;
one or more programs stored in the storage, executable by the processor, the one or more programs comprising:
an image obtaining module operable to obtain images captured by at least three cameras, each of the captured images comprising a distance information indicating a distance between one camera and objects captured by the one camera;
an object detecting module operable to extract the distance information from the obtained captured images;
an orientation information obtaining module operable to obtain an individual orientations of each of the at least three cameras detected by a compass;
a geographical information obtaining module operable to obtain geographical information of the captured images detected by a positioning device; and
a model creating module operable to:
determine images captured by cameras in different orientations and at different geographical positions according to the orientation and the geographical information associated with each of the images;
create 3D models based on the determined images and the extracted distance information;
determine any overlapping portions between the images contributed by each of the cameras; and
align any determined overlapping portion to create a virtual 3D model of the street.

2. The street view creating device as described in claim 1, further comprising an image analysis module, wherein the image analysis module is operable to determine which of the images include moving object(s) and which of the images do not, and the model creating module is operable to create virtual 3D models of the street based on the images which do not include moving object(s) and the extracted distance information.

3. The street view creating device as described in claim 2, wherein the image analysis module is operable to determine images captured in the same orientation and the same geographical information according to the orientation and the geographical information associated with each of the images, compare the distance information of the determined images, determine that moving object(s) is included in one or more image(s) when the relationship between the distance information from one captured image is different from the relationship between the different parts of distance information from another captured image, and further determine the images which do not include moving object(s) as those which do not include any moving object.

4. The street view creating device as described in claim 1, further comprising a model analysis module, the model analysis module is operable to obtain the pixel values of each of the pixels in each of the images captured at one geographical location, determine an average pixel value of each of the pixels of the all images captured at the same geographical information, and assign the determined average pixel value of each of the pixels of the images to the corresponding pixel of the single composite image which shows a virtual 3D model of the street to create a street view with color.

5. A street view creating method comprising:
obtaining images captured by at least three cameras, each of the captured images comprising a distance information indicating a distance between one camera and objects captured by the one camera;
extracting the distance information from the obtained captured images;
obtaining an individual orientations of each of the at least three cameras detected by a compass;
obtaining geographical information of the captured images detected by a positioning device; and
determining images captured by cameras in different orientations and at different geographical positions according to the orientation and the geographical information associated with each of the images;
creating 3D models based on the determined images and the extracted distance information;
determining any overlapping portions between the images contributed by each of the cameras; and
aligning any determined overlapping portion to create a virtual 3D model of the street.

6. The street view creating method as described in claim 5, wherein the method further comprises:
determining which of the images include any moving object(s) and which of the images do not; and
creating virtual 3D models of the street based on the images which do not include moving object(s) and the extracted distance information.

7. The street view creating method as described in claim 6, wherein the determining step further comprises:
determining images captured at the same orientation and the same geographical information according to the orientation and the geographical information associated with each of the images;
comparing the distance information of the determined images;
determining that moving object(s) is included in one or more image(s) when the relationship between the distance information from one captured image is different from the relationship between the different parts of distance information from another captured image; and
determining the images which do not include moving object(s) as those which do not include any moving object.

8. The street view creating method as described in claim 5, the method further comprises:
obtaining the pixel value of each of the pixels in each of the images captured at the one geographical location;
determining an average pixel value of each of the pixels of the all images captured at the same geographical information; and
assigning the determined average pixel value of each of the pixels of the images to the corresponding pixel of the single composite image which shows a virtual 3D model of the street to create a street view with color.

9. A non-transitory storage medium storing a set of instructions, the set of instructions capable of being executed by a processor of a street view creating device, cause the street view creating device to perform a street view creating method, the method comprising:
obtaining images captured by at least three cameras, each of the captured images comprising a distance information indicating a distance between one camera and objects captured by the one camera;
extracting the distance information from the obtained captured images;
obtaining an individual orientations of each of the at least three cameras detected by a compass;
obtaining geographical information of the captured images detected by a positioning device;
determining images captured by cameras in different orientations and at different geographical positions according to the orientation and the geographical information associated with each of the images;
creating 3D models based on the determined images and the extracted distance information;
determining any overlapping portions between the images contributed by each of the cameras; and
aligning any determined overlapping portion to create a virtual 3D model of the street.

10. The non-transitory storage medium as described in claim 9, wherein the method further comprises:
determining which of the images include moving object(s) and which of the images do not; and
creating virtual 3D models of the street based on the images which do not include moving object(s) and the extracted distance information.

11. The non-transitory storage medium as described in claim 10, wherein the determining step comprises:
determining images captured in the same orientation and the same geographical information according to the orientation and the geographical information associated with each of the images;
comparing the distance information of the determined images;
determining that moving object(s) is included in one or any image(s) when the relationship between the distance information from one captured image is different from the relationship between the different parts of distance information from another captured image; and
determining the images which do not include moving object(s) as those which do not include any moving object.

12. The non-transitory storage medium as described in claim 9, wherein the determining step comprises:
obtaining the pixel values of each of the pixels in each of the images captured at one geographical location;
determining an average pixel value of each of the pixels of the all images captured at the same geographical information; and
assigning the determined average pixel value of each of the pixels of the images to the corresponding pixel of the single composite image which shows a virtual 3D model of the street to create a street view with color.
